(19) United States
(12) Patent Application Publication
(10) Pub. No.: US 2008/0294377 A1
(43) Pub. Date: Nov. 27, 2008

(54) Method for Automatic Detection of Operational Performance Data of Reading Systems

(75) Inventor: Werner Hautsch, Radolfzell (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, München (DE)

(21) Appl. No.: 11/630,495

(22) PCT Filed: May 27, 2005
(86) PCT No.: PCT/EP2005/005711

§ 371 Date: Dec. 21, 2006

(30) Foreign Application Priority Data
Jun. 24, 2004 (DE) 10 2004 030 415.7

(51) Int. Cl. B07C 9/00

(52) U.S. Cl. 702/182

(57) ABSTRACT

To detect operational performance data of reading systems images of the delivery surfaces featuring the delivery addresses are stored together with associated reading results. Relevant delivery address the images stored in the performance data memory under the respective delivery characteristic are video coded, and the coding result are stored in the performance data memory under the relevant delivery characteristic. The reading results of the OCR reader and the associated video coding results are compared for each delivery characteristic contained in the performance data memory. The video coding results and the evaluation result are stored under the relevant delivery characteristic and a statistical evaluation is performed for determining error or reading rates relative to the system.

Most of the systems currently used for automatic sorting of deliveries contain reading systems, with the aid of which information written on the item, such as the delivery address, is automatically read and the distribution information needed for sorting can be obtained from this. Written information/addresses which cannot be detected by the reading system with the required certainty are subsequently further processed in a video coding system. In this case the electronic images of the deliveries are displayed at screen-based workstations. The task of the coding operators at these workstations is to manually determine the information necessary for the sorting of the deliveries. This does not involve transcribing the address. Such a process is far too expensive and would lead to an entirely unsatisfactory costs situation. Instead specific coding rules are established which precisely take account of the relevant address structures, in accordance with which only specific parts of the address have to be entered. This extracted information is to be defined so that the necessary distribution information can in most cases be uniquely obtained and the coding operators need only make a further decision in a few cases. Example: The address

### Siemens Dematic:

Bücklestraβe 1-5

### 78467 Konstanz

is abbreviated in the video coding system to:
78467 Bücl.

This method is known as extraction coding.

The most important aspect of applying this technology is to provide reliable performance data of the reading and video encoding system during operation for monitoring and planning. In detecting this performance data it is important to determine values which are representative, valid over long periods of time and simultaneously to provide material for targeted ongoing analyses.

These requirements have only been able to be met very incompletely in the past:

Although it is easy to measure the proportion of the automatically read delivery items and the items processed by the video coding system, these figures are not very meaningful if no reference can be established for the quality of the delivery or the arrangement and readability of the written information. Since the reading rate for handwritten addresses is significantly lower than the reading rate for typewritten addresses, the proportion of handwritten addresses which changes according to day of the week or season (e.g. Christmas) leads to these types of fluctuation of the reading rates, entirely concealing other important influences.

Even more difficult is fully detecting the error rates of the system in operational mode:

Usually incorrect sorting is only detected at the delivery office or mostly even by the delivery staff. At this point it is not longer possible with acceptable effort to draw conclusions about the system causing the error and to determine representative, sample values of the bit error rates.

Experience has shown that this repeatedly leads to misunderstandings between the manufacturers of these systems and their users: The fact that an increased proportion of mis-sortings is occurring at a delivery company does not necessarily mean that general conclusions can be drawn about the contractually agreed error rates being exceeded.

Differences of opinion of this type were mostly only able to be resolved in the past by retrospective, mostly very expensive measurements: In selected offices samples were selected manually from all processed deliveries over a specific period of time. Electronic images of these deliveries were created, collected into a test sample and processed once again through a system corresponding to the operational reading system.

By visual comparison of the individual reading results with the actual addresses, with the inclusion of the data contained in the address directory, the reading and error rates of the reading system were determined.

Obviously this method naturally only provides information about the selected offices and the selected measurement period and thus no information about the errors previously established, unless these error recur by chance in the test sample.

Providing information about incorrect entries by the coding operators (typing errors and careless mistakes) is basically not possible with this method.

The object of the invention is to create a method for automatic detection of operational performance data of reading and/or video coding systems for reading delivery addresses, with which the performance data, such as reading and error rates, and causes of errors are determined for each time segment of operational mode.

In accordance with the invention the object is achieved by the features of claim 1.

In this case the following steps are executed:
Storing the images of the delivery-surfaces featuring the delivery addresses to be read of each nth delivery together with associated reading results and part results of the respective OCR reader and available coding results from the operational processing method, if the coding depth corresponds to the reading depth, under the respective delivery characteristic in a performance data memory
Video coding of the relevant delivery addresses of the images stored in the performance data memory under the respective delivery characteristic by a second coding operator with a coding depth corresponding to the read depth and storing the coding result in the performance data memory under the relevant delivery characteristic,
automatic comparison of the reading results of the OCR reader and the associated video coding results of the previous step for each delivery characteristic contained in the performance data memory, if they do not match, performing of video coding by one or more further coding operators and additional automatic comparison with these coding results for making a majority decision,
Storing all video coding results and the evaluation result under the relevant delivery characteristic and statistical evaluation for determining error or reading rates relative to the system as a whole and/or parts of it and/or coding operators and/or determining the frequency of ambiguous, non-interpretable or unreadable delivery address. In this way reliable initial values for the cost effective evaluation and planning of such systems can be provided.

Advantageous embodiments of the invention are set down in the subclaims.

Thus the statistical evaluation of the reading and error rates can also be undertaken relative to the types of delivery or address categories.

The invention is explained below in an exemplary embodiment with reference to the drawing.

The figures show

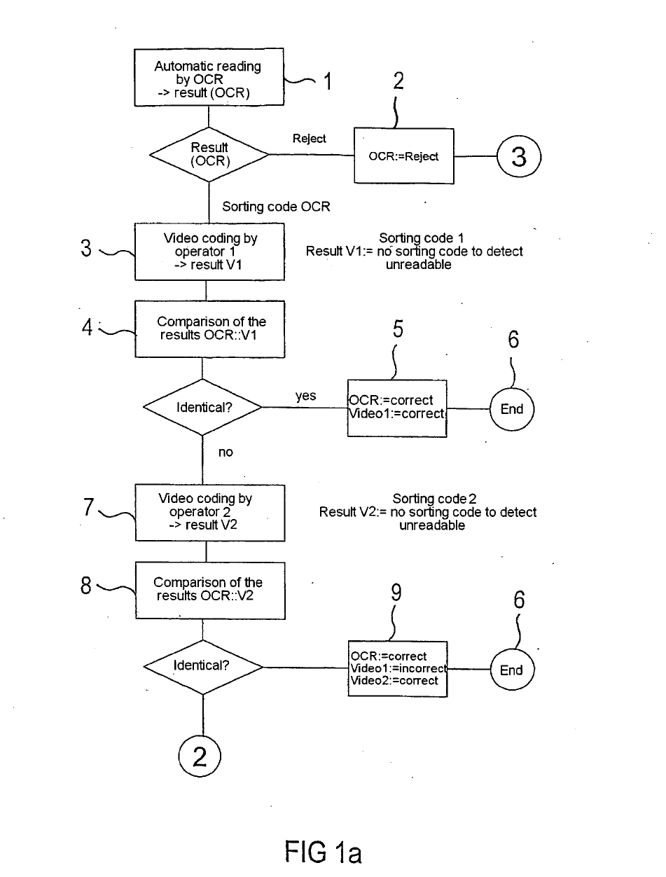

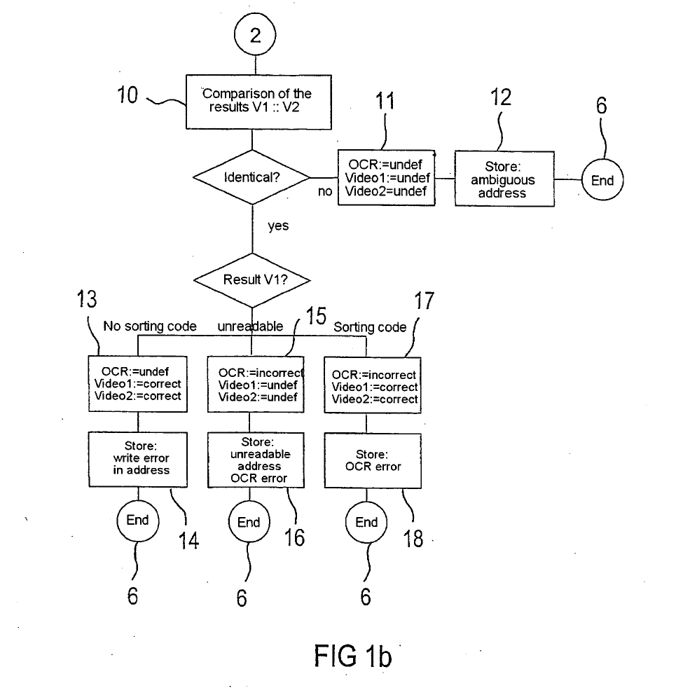

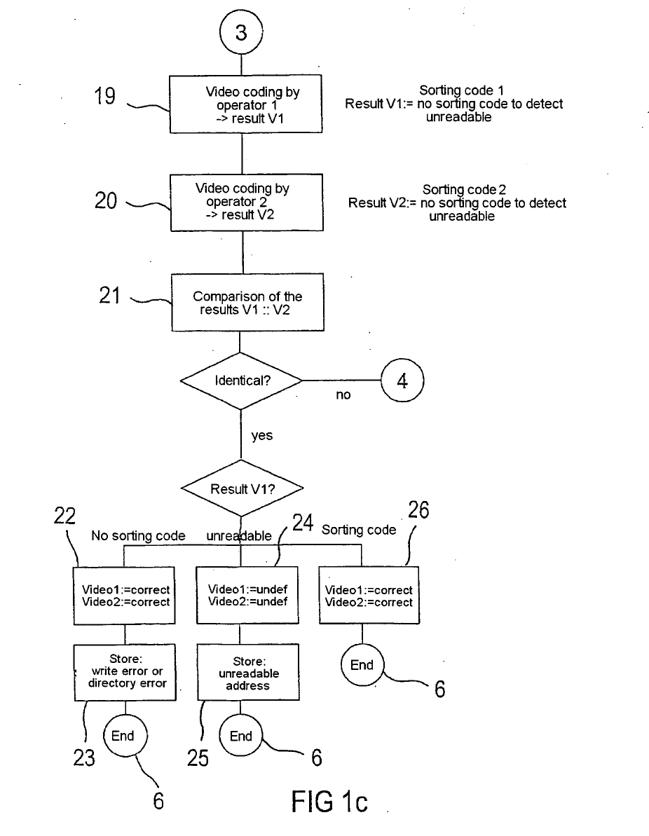

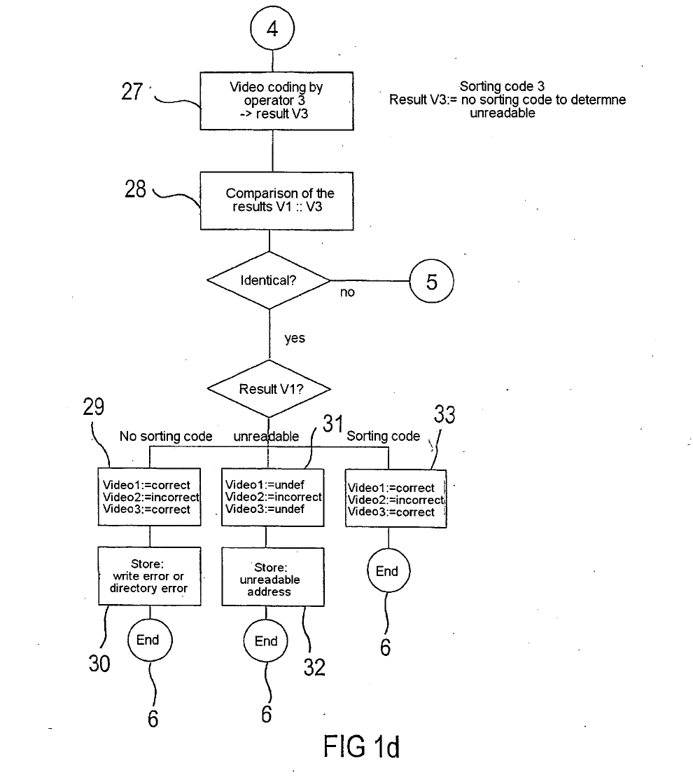

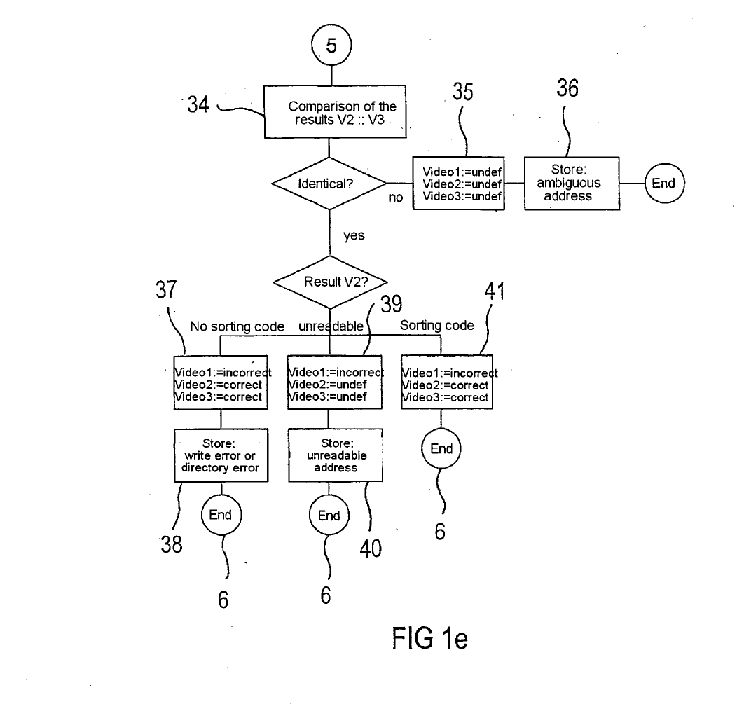

FIG. 1a-e a flowchart of the execution sequence of the method

For statistical evaluation the following information is recorded in addition to the images of the deliveries:
The origin of the images (sorting machine),
Processing reading system and video coding staff involved,
All results of the reading systems
the distinction made by the OCR reader between handwriting and typewritten information.

This information is used to relate the quality data obtained to specific sorting machines, reading systems and video coding staff as well as selectively to handwriting or typewritten information.

The correctness of the reading results obtained from the OCR readers is checked by correlation with the video coding results.

The addresses stored in a performance data memory successfully read by the OCR reader are transferred for checking the results to the video coding system. The sorting information produced by the video coding is compared to the results of the OCR reader.

If they match it is assumed that both results are correct. If the results differ, a second coding operator is enlisted in order to reach a majority decision as to which of the two results is correct:

If the video coding input of the two operators matches but leads however to sorting information which deviates from the reading result of the OCR reader, the reading result of the OCR reader is considered to be incorrect and is included in the statistics as such.

If both the coding operators consider the delivery address to be unreadable and do not make any video coding entry, the reading result is also considered to be incorrect. It is then to be assumed that the delivery does not bear any readable address but that the OCR reader has however misinterpreted other information on the delivery.

If the result entered by the second operator matches the reading result this points to a coding error of the first coding operator during operation and as such is to be included in the statistics.

If the second coding operator produces a result which deviates from the entry made by the first coding operator and from the OCR reading result it is highly probable that the address concerned is ambiguous. No data about the correctness of the reading result is then possible. The delivery should be subjected to a further check.

When comparing the results it is of great importance for the sorting depths of the OCR reader and of the video coding system to be the same:

A video coding system which only allows zip codes to be entered is not able to detect zip codes which do not match the address. If, for the address given as an example above, the incorrect zip code 78462 is used instead of 78467, the OCR reader would be entirely able to detect this error and supply the correct zip code as a result. By contrast the video coding system only encoding the zip code would in both cases deliver the result 78462 and thus incorrectly conclude that the OCR reader involved has made an error.

The case can also occur in which no sorting information can be determined from the entry made by the two coding operators. This indicates a typing error in the address which could be automatically corrected by the OCR reader.

### EXAMPLE

If the above example address contains a typing error made by the sender:

### Siemens Dematic AG

Böcklestr. 1-5

### 78467 Konstanz

then the coding operator would enter: 78467 böcl

This however would not produce any sorting results since there is no street starting with these letters in the city of Konstanz. The reading system on the other hand is able to compensate for such small typing errors. Information about the correctness of the reading result cannot however be obtained in this way.

The error statistics can be related in such cases to individual OCR readers and thus indicate specific problems of this system.

The images of the incorrectly read deliveries can be stored for subsequent analysis.

The correctness of the video coding entries made in operational mode is checked in a similar way by comparing the sorting information produced by the system with the results of other independent coding operators or by correlation with the results of the OCR reader.

An image contained in the performance data memory with an address which was unable to be read uniquely or completely by the OCR reader and therefore was video-coded in operational mode by a coding operator is transferred to a second independent coding operator for video coding.

If the results match it is assumed that both the video coding entries are correct.

With the different results a third coding operator is consulted in order to reach a majority decision. The result which differs from the majority decision is assessed as an input error.

If all three coding operators arrive at different results it is highly probable that the address cannot be interpreted in a unique manner. No statement about the correctness of the video coding is then possible.

If the input of the two coding operators is identical, but no sorting information can be derived from it, this indicates a write error in the address or a missing entry in the address directory. The entries are considered to be correct. The address is considered to be non-interpretable.

If the two coding operators cannot make any video coding entries and reject the address, the address concerned is deemed to be unreadable or illegible. The rejection is interpreted as correct input.

If the OCR reader was able to read the delivery address, it is not necessary to enlist the third coding operator. The correctness of the video coding entries is then, as described in the section above, determined in correlation with the OCR read result.

Error statistics can in this case optionally be related to all or to one individual coding operator.

The images of the incorrectly coded delivery addresses can be stored for subsequent analysis.

As described above, the correlation of the OCR reading and video coding results also produces information about ambiguous and non-interpretable delivery addresses.

An address is considered to be ambiguous if no majority decision between the results of the OCR reader and two or three coding operators respectively is possible.

An address is considered as non-interpretable if neither the OCR reader nor the entries of the coding operators lead to a sorting result.

The reason for this is either deficiencies of the address or of the address directory used. This decision cannot be made automatically.

The delivery addresses displayed in this way can be used for explicitly rectifying the deficiencies of the address directory.

Addresses which are rejected both by the OCR reader and also by the coding operators are considered to be unreadable. Since further processing of such deliveries requires a very great effort the recording and measurement of its proportion is of great significance here.

The method can be used for all information written on deliveries, such as delivery addresses, sender addresses, sender's instructions, content of forms.

The additional coding operators needed compared to operational mode are spread throughout the normal operational sequence so that there is no difference for the coding operators between normal and test deliveries. The additional load imposed on the video coding system by the extra steps used for a checking is very small since the number of samples can be kept low. If for example every 500th delivery is checked, for a reading rate of 80% and an error rate of 1%, this results in an overhead of 1% in video coding.

This additional effort does not however result in an increase in the numbers employed and the number of coding operators necessary since it can be undertaken at times when the throughput of the machines is low, as a space and gap filler.

This makes it possible to have the measurement system for determining the performance data running in the background all the time during operational mode and thereby to record the progress of performance during the entire period of operation.

The statistical accuracy of the performance data determined depends on the duration of the relevant measurement intervals and on the throughput: In the example above, checking every 500th item with that an average machine throughput of the 30,000 items per hour collects a test sample of 3000 items in 50 hours. In accordance with the calculation of statistical standard deviation Sigma, this sample size allows the error rate of 1% to be determined with a deviation of appr. 0.2% on both sides. By increasing the sampling frequency, by integration over longer periods and more machines, this accuracy can be increased in any required way.

The method is explained below with reference to the flowchart shown.

The images of the test sample linked to the delivery characteristics are first processed by the OCR reader 1. If the OCR reader is successful in this case it delivers as a result the sorting code corresponding to the address.

The correctness of the sorting code is to be checked. For this purpose the image of the delivery is transferred to a coding operator 3. If the OCR reader had not produced a unique or complete result this coding operator is the operator for normal operational mode. The coding sequence entered by them is evaluated by the system. In considering the results three cases are to be identified: In the normal case the result will also be a sorting code. There are however also cases in which no sorting code is to be detected from the coding sequence since the coding sequence or the address itself contains errors. If finally the coding operator cannot detect any viable address at all from the image of the delivery, they must reject the address as unreadable.

The results of this first video coding are now compared to the OCR result 4. If they match, which is not the case with operational video coding, both are considered as correct 5 and are correspondingly counted in the statistics/end 6.

If they do not match, the image of the delivery is transferred for video coding to a further coding operator 7. Their result is now again compared with the OCR result 8. If it is identical, the OCR result and the second video coding are correct, but the first video coding is incorrect 9.

If again no match can be established, the two video coding results are compared to one another 10. If they are identical the further decision is governed by the type of result: If the code concerned is a sorting code, the two coding results are considered as correct, the OCR result as incorrect 17. For further analysis the image leading to the OCR error can be stored 18.

If the two coding results do not produce a sorting code, the error involved is probably a write error in the address which could be corrected by the OCR reader. Whether this has occurred in the correct manner cannot however be established in this way. The OCR result is thus considered as unable to be checked (undefined). The coding operators have however behaved correctly within the framework of the prescribed coding roles and are evaluated accordingly 13. The image of the delivery can be stored as an example of write errors 14. If the coding operator considers the address of the delivery to be unreadable, the OCR result is probably incorrect. Possibly the OCR reader has read the sender's address instead of the unreadable delivery address. However no information can be provided as to the correctness of the video coding 15. The image of the delivery can be stored as an example of unreadable items 16.

If the OCR reader was not able to detect a sorting code the item is evaluated as an OCR reject 2. The item image is then processed by two independent coding operators 19, 20 and their results compared 21. If they are identical the decision is made in the same way as the method described above. If a sorting code was determined by the first coding operators in operational mode, both video coding results are considered as correct 26.

If both coding operators considered the delivery address to be unreadable no information is able to be provided about the correctness of the video coding 24. The image of the delivery can be stored as an example of unreadable delivery addresses 25. If a valid sorting code could not be determined the video codings are viewed as correct 22 and the image is stored as an example for write or directory errors 23.

If the video coding results from the two coding operators are not identical, a third coding operator is enlisted to reach a decision 27. If their result matches the result obtained by the first coding operator, the second video coding is probably incorrect. If a sorting code was determined the first and the third video coding are correct 33, if no valid sorting code was determined both video codings are regarded as correct 29 and the image can be stored under the heading of write or directory errors 30. For the video coding result “unreadable” the image concerned can be stored under unreadable address 31, 32. If the video coding result of the first and the third coding operator is not identical, the video coding result of the second and third coding operator is compared 34. If no match can be established, the results are viewed as undefined 35 and the image can be stored under “ambiguous address” 36. If the video coding results match, the coding of the first coding operator is incorrect. The further decision is again made in a similar way to the method already described 37 to 41.

If no agreement can also be established between the three coding operatives, this delivery is obviously ambiguous.

It should be noted that in accordance with the greatly simplified decision process described, ambiguous items can also be mistaken for errors: If for example, for an address with two different possible interpretations, two coding operatives decide on one interpretation and one coding operator on the other interpretation, the one video coding is considered to be incorrect because of the majority principle. If ambiguous addresses frequently occur, the method allows an expansion of the decision principles by including other coding operatives and by expanding the majority principle: A result is then only considered as incorrect if all other results (number >n=2) unanimously contradict the result considered.

1. A method for automatic detection of operational performance data of reading systems, including OCR readers and video coding systems, for reading delivery addresses, in which images of the delivery surfaces are recorded with the delivery addresses of each delivery and then the delivery addresses are automatically read in the OCR reader, in which case, if a read result is not available or not unique, the delivery addresses are video-coded by a video coding operator,
comprising:
storing the images of the delivery surfaces, which include the delivery addresses to be read of each nth delivery, together with associated reading results and partial results of the respective OCR reader and available coding results from the operational mode, if a coding depth corresponds to a reading depth, under a respective delivery characteristic in a performance data memory,
video coding relevant delivery addresses of the images stored in the performance data memory under the respective delivery characteristic by a second coding operator with a coding depth corresponding to the reading depth, and storing the coding result in the performance data memory under the relevant delivery characteristic,
automatically comparing the reading results of the OCR reader and the associated video coding results of the previous step for each delivery characteristic contained in the performance data memory and, if available, the video coding results from operational activity, if they do not match, performing of video coding by one or more further coding operators and additional automatic comparison with these coding results for making a majority decision, and
storing all video coding results and the evaluation result under the relevant delivery characteristic and statistical evaluation for determining error or reading rates relative to the system as a whole and/or parts of it and/or coding operators and/or for determining the frequency of ambiguous, non-interpretable or unreadable delivery addresses.

2. The method of claim 1, wherein a statistical evaluation of the reading and error rates is undertaken in relation to types of delivery and address categories.
